(19) United States
(12) Patent Application Publication
(10) Pub. No.: US 2026/0074623 A1
(43) Pub. Date: Mar. 12, 2026

(54) ENERGY HARVESTING CIRCUIT

(71) Applicant: Resideo LLC, Golden Valley, MN (US)

(72) Inventors: Hyunki Kim, Rogers, MN (US); Peter Anderson, Saint Paul, MN (US); John D. Mitchell, Maple Grove, MN (US)

(73) Assignee: Resideo LLC, Golden Valley, MN (US)

(21) Appl. No.: 19/320,259

(22) Filed: Sep. 5, 2025

Related U.S. Application Data
(60) Provisional application No. 63/691,717, filed on Sep. 6, 2024.

(51) Int. Cl. H02M 3/335; F24H 9/20; H02M 1/36; H02M 3/338

(52) U.S. Cl. CPC H02M 3/33571; F24H 9/2035; H02M 3/3384; H02M 1/36

(57) ABSTRACT

A power converter includes an inductor configured to be coupled with a direct current voltage source. The power converter includes a first switching device coupled with the inductor and a second switching device coupled with the inductor. The first switching device and the second switching device are arranged in parallel. The first switching device and the second switching device have a similar drain resistance.

### RELATED APPLICATION(S)

This application claims priority to and the benefit of U.S. Provisional Application No. 63/691,717, filed Sep. 6, 2024, the contents of which are incorporated herein by reference in its entirety.

### FIELD

This disclosure relates generally to gas-powered appliances. More particularly, this disclosure relates to power management for thermally powered control circuits in gas-powered appliances.

### BACKGROUND

Gas-powered appliances, such as a water heater, a fireplace insert or a furnace, typically include a control system included for controlling the operation of the appliance. “Gas-powered” typically means natural gas or liquid propane gas is used as a primary fuel source. Current control systems used in gas-powered appliances are typically powered by a source external to the appliance or take the form of a thermo-mechanical system.

### SUMMARY

In some embodiments, a power converter includes an inductor configured to be coupled with a direct current voltage source. In some embodiments, a first switching device is coupled with the inductor. In some embodiments, a second switching device is coupled with the inductor. In some embodiments, the first switching device and the second switching device are arranged in parallel. In some embodiments, the first switching device and the second switching device have a similar drain resistance.

In some embodiments, the power converter is a low-voltage, self-starting oscillator.

In some embodiments, the drain resistance of the first switching device and the second switching device is less than 30 Ohms.

In some embodiments, the power converter includes a third switching device. In some embodiments, the third switching device has a similar drain resistance to the first switching device and the second switching device.

In some embodiments, the first switching device is a field effect transistor.

In some embodiments, the first switching device is a junction field effect transistor.

In some embodiments, the junction field effect transistor is an n-channel junction field effect transistor.

In some embodiments, the first switching device is a metal oxide semiconductor field effect transistor.

In some embodiments, the first switching device and the second switching device have the same drain resistance.

In some embodiments, the first switching device and the second switching device have the same cutoff voltage.

In some embodiments, a system includes a voltage source and a power converter. In some embodiments, the power converter includes an inductor configured to be coupled with a direct current voltage source. In some embodiments, a first switching device is coupled with the inductor. In some embodiments, a second switching device is coupled with the inductor. In some embodiments, the first switching device and the second switching device are arranged in parallel. In some embodiments, the first switching device and the second switching device have a similar drain resistance. In some embodiments, the system includes a charge storage circuit coupled with the power converter and a controller coupled with the power converter and the charge storage circuit.

In some embodiments, the power converter is a low-voltage, self-starting oscillator.

In some embodiments, the drain resistance of the first switching device and the second switching device is less than 30 Ohms.

In some embodiments, the power converter includes a third switching device. In some embodiments, the third switching device has a similar drain resistance to the first switching device and the second switching device.

In some embodiments, the first switching device is a field effect transistor.

In some embodiments, the first switching device is a junction field effect transistor.

In some embodiments, the junction field effect transistor is an n-channel junction field effect transistor.

In some embodiments, the first switching device is a metal oxide semiconductor field effect transistor.

In some embodiments, the first switching device and the second switching device have the same drain resistance.

In some embodiments, the first switching device and the second switching device have the same cutoff voltage.

In some embodiments, a gas-powered appliance includes a voltage source and a power converter. In some embodiments, the power converter includes an inductor configured to be coupled with a direct current voltage source. In some embodiments, a first switching device is coupled with the inductor. In some embodiments, a second switching device is coupled with the inductor. In some embodiments, the first switching device and the second switching device are arranged in parallel. In some embodiments, the first switching device and the second switching device have a similar drain resistance. In some embodiments, the system includes a charge storage circuit coupled with the power converter and a controller coupled with the power converter and the charge storage circuit.

In some embodiments, the gas-powered appliance is a boiler.

In some embodiments, the gas-powered appliance is a water heater.

In some embodiments, the voltage source includes a thermopile.

In some embodiments, the first switching device and the second switching device have the same drain resistance.

In some embodiments, the first switching device and the second switching device have the same cutoff voltage.

In some embodiments, a power converter includes an inductor configured to be coupled with a direct current voltage source. In some embodiments, a first switching device is coupled with the inductor. In some embodiments, a second switching device is coupled with the inductor. In some embodiments, the first switching device and the second switching device are arranged in parallel. In some embodiments, the first switching device and the second switching device have the same drain resistance.

In some embodiments, the first switching device and the second switching device have the same cutoff voltage.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a water heater, according to some embodiments.

FIG. 2 shows a block diagram of a thermally powered control circuit, according to some embodiments.

FIG. 3 shows a block diagram of circuit showing the power converter of FIG. 2, according to some embodiments.

FIG. 4 is a diagram of a thermally powered control circuit, according to some embodiments.

Like reference numbers represent the same or similar parts throughout.

### DETAILED DESCRIPTION

Gas-powered appliances typically include appliances that use natural gas or liquid propane gas as a primary fuel source for combustion. Some examples of gas-powered appliances include, but are not limited to, water heaters, fireplace inserts, furnaces, boilers, or the like.

Embodiments of this disclosure will be discussed with reference to a water heater. It is to be appreciated that the concepts described and illustrated are applicable to other types of gas-powered appliances, but the description will not be duplicated for purposes of simplicity of this disclosure.

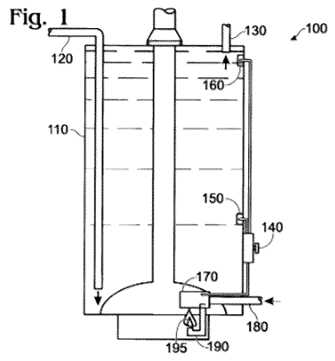

FIG. 1 shows a water heater 100, according to some embodiments. Water heater 100 can include a storage tank 110 for storing water that has been or is to be heated. Water heater 100 can also include a water supply feed pipe 120 and a hot water exit pipe 130. In some embodiments, the water supply feed pipe 120 can receive cold water from a water source associated with a location in which the water heater 100 is installed. In some embodiments, the water heater 100 can also include a selectable input device/control circuit 140, temperature sensor 150, and temperature sensor 160. In some embodiments, information such as water temperature within the tank 110, a preferred water temperature, or a combination thereof, may be communicated, respectively, by temperature sensor 150, temperature sensor 160, and the input device of input device/control circuit 140 to the control circuit of input device/control circuit 140. In some embodiments, such information is communicated using electrical signals. In some embodiments, a thermoelectric device 170 may power input device/control circuit 140.

In some embodiments, water heater 100 includes a gas supply line 180 and a pilot burner/pilot gas valve 190 coupled with input device/control circuit 140. In some embodiments, burner/pilot gas valve 190 may produce a pilot flame 195. In some embodiments, thermal energy supplied by pilot flame 195 may be converted to electric energy by thermoelectric device 170. This electrical energy may then be used by thermally powered input device/control circuit 140 to operate the water heater 100. In some embodiments, the water heater 100 can further include a main burner/main burner gas valve (not shown) to provide thermal energy for heating water contained within tank 110.

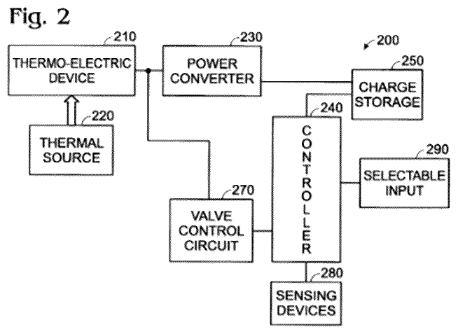

FIG. 2 shows a block diagram of a thermally powered control circuit 200, according to some embodiments. In some embodiments, the circuit 200 can be used in the water heater 100 (FIG. 1). It is to be appreciated that the circuit 200 can be used in other gas-powered appliances in accordance with this disclosure.

In some embodiments, circuit 200 can include a thermoelectric device 210 that is in thermal communication with a thermal source 220. As used herein, thermal communication typically means that thermoelectric device 210 and thermal source 220 are in close enough physical proximity with each other that thermal energy generated by thermal source 220 can be absorbed by, or communicated to, thermoelectric device 210. In some embodiments, thermal energy communicated to thermoelectric device 210 from thermal source 220 can generate an electric voltage potential from thermoelectric device 210.

As is shown in FIG. 2, thermoelectric device 210 may be coupled with power converter 230. Power converter 230, which will be discussed in further detail below, may modify the voltage potential produced by thermoelectric device 210. Typically, because the voltage potential produced by thermoelectric device 210 is lower than desired for operating most circuit components, power converter 230 may be a step-up power converter. Power converter 230 may be further coupled with a controller 240 and a charge storage circuit 250. In some embodiments, controller 240 can be an ultra-low power microcontroller. Charge storage circuit 250 can include circuit components, such as, for example, capacitors to store charge for use by controller 240, and for use in stepping up the voltage potential generated by thermoelectric device 210.

In some embodiments, circuit 200 can include a valve control circuit 270. Valve control circuit 270 can be coupled with controller 240 such that controller 240 can initiate opening and closing of one or more gas valves associated with valve control circuit 270, during normal operation of, for example, water heater 100.

In some embodiments, circuit 200 includes one or more sensing devices 280 and an input selection device 290, which can be coupled with controller 240. Sensing devices 280 can take the form of negative temperature coefficient (NTC) thermistors, which, for the embodiment illustrated in FIG. 1, can sense water temperature within storage tank 110. Controller 240 can compare information received from sensing devices 280 with a threshold value that is based on a setting of selection device 290. Using this comparison, controller 240 can initiate valve control circuit 270 to open a main burner valve to heat water within water heater 100. In some embodiments, controller 240 can initiate valve control circuit 270 to close a main burner valve to end a heating cycle in water heater 100. It is to be appreciated that in applications other than water heaters, the sensing devices 280 can sense an input other than water temperature, such as an ambient air temperature or the like.

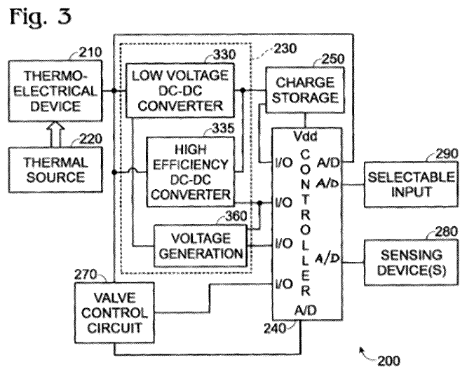

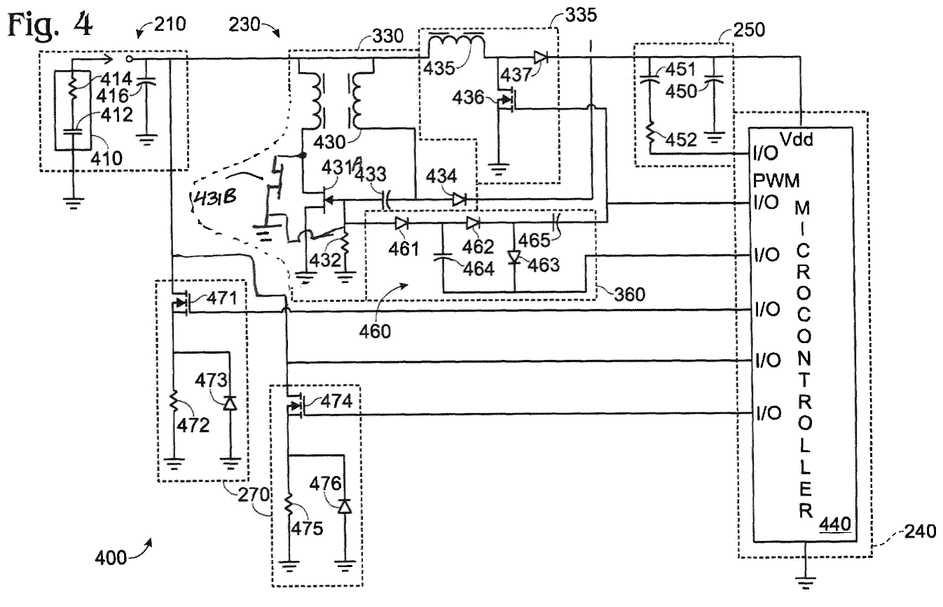

FIG. 3 shows a block diagram of circuit 200 showing power converter 230 in further detail, according to some embodiments. As illustrated in FIG. 3, power converter 230 can include a low voltage direct current to direct current voltage converter (DC-DC converter) 330, a high-efficiency DC-DC converter 335, and a voltage generation circuit 360. In some embodiments, low-voltage DC-DC converter 330, high-efficiency DC-DC converter 335, and voltage generation circuit 360 can operate in conjunction with charge storage circuit 250 and controller 240 to serve as a power management system, according to some embodiments. The low-voltage DC-DC converter 330, high-efficiency DC-DC converter 335, and the voltage generation circuit 360 are discussed in additional detail in FIG. 4 below.

FIG. 4 is a schematic diagram of a thermally powered control circuit 400, according to some embodiments. Circuit 400 is similar to circuit 200 depicted in FIGS. 2 and 3 above. For simplicity of this Specification, elements that have been previously described will not be described again in further detail.

In the illustrated embodiment, circuit 400 includes thermoelectric device 210, which can take the form of thermopile 410 and capacitor 416. In some embodiments, thermopile 410 includes battery 412, which represents the open-circuit thermopile voltage, and resistor 414, which represents the internal resistance of thermopile 410. Capacitor 416 may provide wave shaping for the thermal voltage generated by thermopile 410 as well as improving the overall efficiency of circuit 400.

Thermopile device 410 may be coupled with power converter 230, specifically low-voltage DC-DC converter 330 and high-efficiency DC-DC converter 335, for converting the thermally generated voltage. Low-voltage DC-DC converter 330 can include a transformer 430. Low-voltage DC-DC converter 330 can include a plurality of electronic switches 431A, 431B for completing a positive feedback loop that facilitates oscillation of DC/DC converter 330. For circuit 400, these switches 431A, 431B may take the form of n-channel junction field effect transistors or n-channel depletion mode field effect transistors (collectively FETs) 431A, 431B. Low-voltage DC-DC converter 330 can include a capacitor 433, transformer 430, FETs 431A, 431B, resistor 432, and capacitor 433, forming a low-voltage, self-starting oscillator. In some embodiments, when the input voltage to transformer 430 has sufficient potential (approximately 100 mV), this oscillator begins to oscillate.

In some embodiments, FETs 431A and 431B have similar parameters. In some embodiments, FETs 431A and 431B have the same parameters. In some embodiments, if the FETs 431A, 431B have different parameters, performance of the pilot gas valve 190 may be poorer than instances in which the FETs 431A, 431B have similar or the same parameters. In some embodiments, the performance degradation can cause the pilot gas valve 190 to open more than 10 seconds slower than embodiments in which the FETs 431A, 431B have similar or the same parameters. In the illustrated embodiment, two FETs 431A, 431B arranged in parallel are shown. It is to be appreciated that more than two FETs can be included (e.g., three or more) in parallel. In some embodiments, three or more FETs are also included having similar or the same parameters. In some embodiments, the FETs 431A, 431B have a similar drain resistance. In some embodiments, the FETs 431A, 431B have the same drain resistance. In some embodiments, the drain resistance is less than 30 Ohms.

In some embodiments, one or more additional parameters of the FETs 431A, 431B can be selected to be similar or the same. For example, in some embodiments, the cutoff voltage of FETs 431A, 431B can be the same as or similar to each other. In some embodiments, the FETs 431A, 431B can have the same drain resistance and the same cutoff voltage. As a result, in some embodiments, the two FETs can have the same on/off timing.

In some embodiments, the FETs 431A, 431B are junction field effect transistors. In some embodiments, the FETs 431A, 431B are n-channel junction field effect transistors. In some embodiments, the FETs 431A, 431B are metal oxide semiconductor field effect transistors.

Low-voltage DC-DC converter 330 further includes a rectifying diode 434 with its anode coupled with the positive terminal of the secondary windings of transformer 430 and capacitor 433. Because the voltage generated by thermopile 410 is relatively low as compared to the desired operation voltage of the circuit elements of circuit 400, transformer 430 may have a ratio of turns of its primary windings to turns of the secondary windings of approximately one to thirty in order to facilitate stepping up the thermal voltage.

In some embodiments, power converter 230 includes high-efficiency DC-DC converter 335, which may be coupled with thermoelectric device 210 and low-voltage DC-DC converter 330. While these two converters are both electrically connected to thermoelectric device 210 at the same electrical node, they have no interaction with one another with respect to conversion of the thermal voltage generated by thermoelectric device 210. In some embodiments, high-efficiency DC-DC converter 335 may take the form of a boost converter, which includes an inductor 435 coupled with thermoelectric device 210. High-efficiency DC-DC converter 335 can include a field effect transistor (FET) switch device 436 coupled with inductor 435 and a controller 240, which is described further hereinafter, and a rectifying diode 437 coupled with inductor 435 and switch 436.

In some embodiments, power converter 230 may also include voltage generation circuit 360, which for circuit 400 takes the form of a negative charge pump 460. Negative charge pump 460 may be coupled with the gate terminal of FET 431 and comprise diodes 461, 462 and 463 and capacitors 464 and 465. In operation, negative charge pump 460 may be pumped by controller 240 to disable low-voltage DC-DC converter 330 after high-efficiency DC-DC converter 335 is enabled.

Circuit 400 may also include charge storage circuit 250, which is coupled with power converter 230 and controller 240 to provide a power supply voltage (Vdd) to controller 240. In some embodiments, charge storage circuit 250 can include a first capacitor 450, a second capacitor 451, and a resistive element 452. Capacitor 450 can be relatively small as compared to capacitor 451, typically one-tenth to one-hundredth the size. In some embodiments, for water heater 100, capacitor 450 may have a value of ten (10) microfarads (uf) and capacitor 451 may have a value of one hundred (100) uf to one (1) millifarad. Such a configuration can improve the startup times of circuit 400, as low-voltage DC-DC converter stores electrical energy on smaller capacitor 450. In this regard, because such low-voltage DC-DC converters are typically not efficient and deliver relatively little power as compared to DC-DC converters that operate at high voltages, use of capacitors 450 and 451 in such a configuration may allow Vdd to be stepped up from the thermal voltage more quickly than if a single capacitor the size of capacitor 451 were used.

In some embodiments, circuit 400 includes controller 240, which may take the form of a programmable microcontroller 440. In some embodiments, microcontroller 440 may be an ultra-low power microcontroller. Microcontroller 440 may include an analog-digital conversion circuit, a timer circuit, a pulse-width modulated output channel, a power supply voltage sensing circuit, a temperature sensing circuit, and a low-voltage (brown-out) function mode. These features of microcontroller 440 may enable it to carry out the functions of power management for circuit 400.

In some embodiments, as shown in FIG. 4, multiple I/O channels of microcontroller 440 maybe coupled with high-efficiency DC-DC converter 335, charge pump 460, and charge storage circuit 250. Microcontroller 440 can contain machine executable instructions for operating circuit 400.

In some embodiments, circuit 400 includes valve control circuit 270, which is coupled with microcontroller 440 and thermoelectric device 210. In some embodiments, valve control circuit 270 includes valve drivers 471 and 474, and associated gas valves which resistors 472 and 475 represent. Valve drivers 471 and 474 can take the form of FETs having their gate terminals coupled with I/O channels of microcontroller 440 such that gas valves 472 and 475 are opened and closed using, at least in part, electrical signals generated by microcontroller 440. In some embodiments, valve control circuit 270 includes free-wheeling diodes 473 and 476, which allow current from the inductance of valves 472 and 475, respectively, to free wheel when the valve drivers are turned off by microcontroller 440.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A power converter, comprising:
an inductor configured to be coupled with a direct current voltage source;
a first switching device coupled with the inductor; and
a second switching device coupled with the inductor;
wherein the first switching device and the second switching device are arranged in parallel; and
wherein the first switching device and the second switching device have a similar drain resistance.

2. The power converter of claim 1, wherein the power converter is a low-voltage, self-starting oscillator.

3. The power converter of claim 1, wherein the drain resistance of the first switching device and the second switching device is less than 30 Ohms.

4. The power converter of claim 1, further comprising a third switching device.

5. The power converter of claim 1, wherein the first switching device is a field effect transistor.

6. The power converter of claim 5, wherein the first switching device is a junction field effect transistor.

7. The power converter of claim 6, wherein the junction field effect transistor is an n-channel junction field effect transistor.

8. The power converter of claim 5, wherein the first switching device is a metal oxide semiconductor field effect transistor.

9. A system, comprising:
a voltage source;
a power converter,
wherein the power converter comprises:
an inductor configured to be coupled with a voltage source;
a first switching device coupled with the inductor; and
a second switching device coupled with the inductor;
wherein the first switching device and the second switching device are arranged in parallel;
a charge storage circuit coupled with the power converter; and
a controller coupled with the power converter and the charge storage circuit.

10. The system of claim 9, wherein the power converter is a low-voltage, self-starting oscillator.

11. The system of claim 9, wherein a drain resistance of the first switching device and the second switching device is less than 30 Ohms.

12. The system of claim 9, further comprising a third switching device.

13. The system of claim 9, wherein the first switching device is a field effect transistor.

14. The system of claim 13, wherein the first switching device is a junction field effect transistor.

15. The system of claim 14, wherein the junction field effect transistor is an n-channel junction field effect transistor.

16. The system of claim 13, wherein the first switching device is a metal oxide semiconductor field effect transistor.

17. A gas-powered appliance comprising:
a voltage source;
a power converter,
wherein the power converter comprises:
an inductor configured to be coupled with a voltage source;
a first switching device coupled with the inductor; and
a second switching device coupled with the inductor;
wherein the first switching device and the second switching device are arranged in parallel;
a charge storage circuit coupled with the power converter; and
a controller coupled with the power converter and the charge storage circuit.

18. The gas-powered appliance of claim 17, wherein the gas-powered appliance is a boiler.

19. The gas-powered appliance of claim 17, wherein the gas-powered appliance is a water heater.

20. The gas-powered appliance of claim 17, wherein the voltage source comprises a thermopile.

21. A power converter, comprising:
an inductor configured to be coupled with a direct current voltage source;
a first switching device coupled with the inductor; and
a second switching device coupled with the inductor;
wherein the first switching device and the second switching device are arranged in parallel; and
wherein the first switching device and the second switching device have the same drain resistance.

22. The power converter of claim 21, wherein the first switching device and the second switching device have the same cutoff voltage.
